(19) United States
(12) Patent Application Publication
(10) Pub. No.: US 2022/0314247 A1
(43) Pub. Date: Oct. 6, 2022

(54) LOOSE FILL INSULATION DELIVERY SYSTEM WITH ADDITIVE INJECTION AND METHOD OF INCLUDING ADDITIVE IN LOOSE FILL INSULATION

(71) Applicant: CertainTeed LLC, Malvern, PA (US)

(72) Inventors: Bruce A. Hartzell, Micketon, NJ (US); Michael J. Lembo, Souderton, PA (US)

(21) Appl. No.: 17/701,234

(22) Filed: Mar. 22, 2022

Related U.S. Application Data
(60) Provisional application No. 63/164,919, filed on Mar. 23, 2021.

(30) Foreign Application Priority Data
Jun. 10, 2021 (EP) 21178820.3

(51) Int. Cl. B05B 5/00; E04F 21/08

(52) U.S. Cl. CPC B05B 5/002; E04F 21/085

(57) ABSTRACT

The present disclosure relates generally to loose fill insulation installation systems, for example, suitable for installing loose fill insulation to an installation site. The present disclosure relates more particularly to a loose fill insulation delivery system including a hopper configured to receive loose fill insulation, a blower operable to convey loose fill insulation along a path toward an installation site, and an inlet port located along the path. The inlet port is configured to introduce a first additive into loose fill insulation travelling along the path toward the installation site.

### BACKGROUND OF THE DISCLOSURE

### 1. Field of the Disclosure

The present disclosure relates generally to loose fill insulation installation systems, for example, suitable for installing loose fill insulation to an installation site. The present disclosure relates more particularly to a system to deliver loose fill insulation using an insulation blowing machine.

### 2. Technical Background

Loose fill insulation is packaged in bags in which the material becomes compacted prior to storage and shipment. When removed from the bags, the insulation separates into clumps or nodules. In order to effectively install the insulation material, it is initially conditioned to increase its volume and to reduce its density. Traditionally, pneumatic devices are used to both install the insulation and perform the conditioning. The conditioning process breaks up the clumps and extends the fibers so as to “open up’ the insulation, allowing it to return to its more flake-like form. The conditioned insulation is then applied pneumatically to an area by blowing it through a hose connected to the pneumatic device. In some cases, the packaged loose fill insulation includes additives to impart various different characteristics to the insulation.

While existing systems for installing loose fill insulation are effective, the present inventors have identified certain aspects of these systems that can be improved.

### SUMMARY OF THE DISCLOSURE

In one aspect, the present disclosure provides a loose fill insulation delivery system comprising:
a hopper configured to receive loose fill insulation;
a blower operable to convey loose fill insulation along a path toward an installation site; and
an inlet port located along the path and configured to introduce a first additive into loose fill insulation travelling along the path toward the installation site.

In another aspect, the disclosure provides a method of delivering loose fill insulation to an installation site using the system of the disclosure, the method comprising:
loading loose fill insulation into the hopper;
operating the blower to convey the loose fill insulation along a path to the installation site; and
introducing a first additive into the loose fill insulation travelling along the path through an inlet port.

Additional aspects of the disclosure will be evident from the disclosure herein.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a schematic side view of a loose fill insulation delivery system according to an embodiment of the disclosure;

FIG. 2 is a schematic front view of the loose fill insulation delivery system of FIG. 1;

FIG. 3 is a schematic side view of a loose fill insulation delivery system according to another embodiment of the disclosure;

FIG. 4 is a schematic side view of a loose fill insulation delivery system according to another embodiment of the disclosure;

FIG. 5 is a schematic side view of a loose fill insulation system according to another embodiment of the disclosure;

FIG. 6 is a schematic cross-sectional view of a portion of a loose fill insulation hose of the loose fill insulation delivery system of FIG. 3;

FIG. 7 is a schematic cross-sectional view of a portion of a loose fill insulation hose of the loose fill insulation delivery system of FIG. 5; and

FIG. 8 is a schematic cross-sectional view of a portion of the loose fill insulation delivery system of FIG. 3.

### DETAILED DESCRIPTION

The present inventors have identified that additives provided in packaged loose fill insulation may be wasted, either because they are not needed for a particular installation, or because a portion of the additives are left in the blowing machine as a result the conditioning process.

Accordingly, one aspect of the disclosure is a loose fill insulation delivery system including a hopper configured to receive loose fill insulation, a blower operable to convey loose fill insulation along a path toward an installation site, and an inlet port located along the path. The inlet port is configured to introduce a first additive into loose fill insulation travelling along the path toward the installation site.

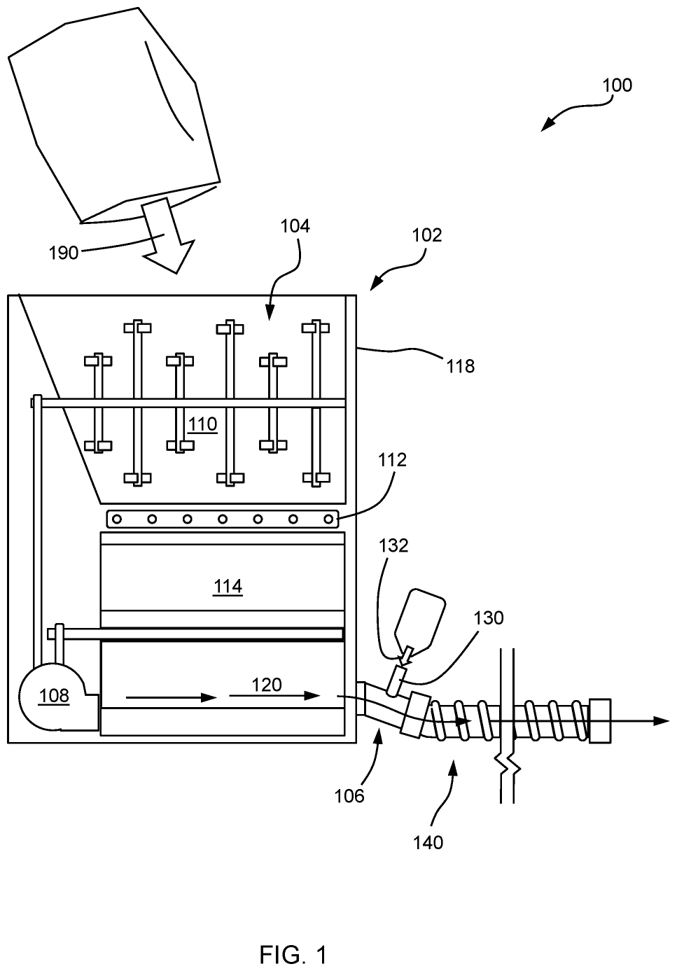

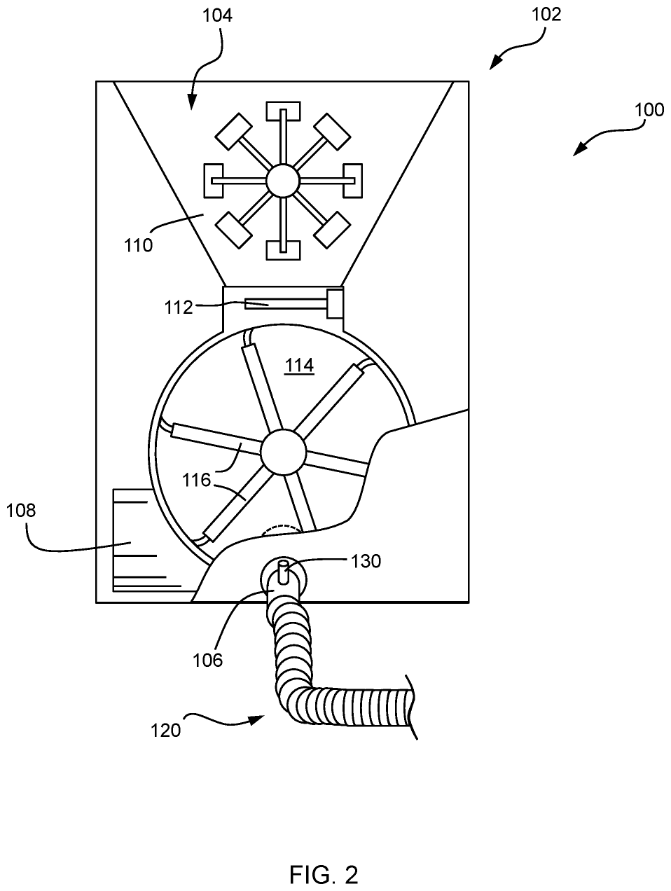

Such a loose fill insulation delivery system is schematically shown in FIGS. 1 and 2. Loose fill insulation system 100 includes a hopper 104 configured to receive loose fill insulation 190. A blower 108 in fluid communication with the loose fill insulation 190 received in the hopper 104 forces air along a path 120 toward an installation site. The air moved by the blower 108 conveys the loose fill insulation along the path 120 toward the installation site. Further, an inlet port 130 is disposed along the path 120 for introducing a first additive 132 to the loose fill insulation. As explained in more detail below, the first additive may include any of various substances for providing certain characteristics to the loose fill insulation. For example, the first additive may include an antistatic agent, dust suppressant, mold suppressant, moisture control agent, fire retardant, or pest control agent.

In certain embodiments of the loose fill insulation delivery system, the hopper and blower are part of a loose fill insulation blowing machine. For example, hopper 104 and blower 108 of loose fill insulation delivery system 100 are both integrated into a loose fill blowing machine 102 that receives the packed loose fill insulation 190, conditions the insulation, and conveys it along the path 120 toward the installation site. In other embodiments, the hopper and blower may be discrete components in the loose fill insulation delivery system, which may include additional components for conditioning and directing the insulation.

In certain embodiments of the loose fill insulation delivery system, the loose fill insulation blowing machine includes an air lock configured to transfer the loose fill insulation to the outlet. For example, blowing machine 102 includes an air lock 114 disposed downstream of hopper 108. The air lock 114 includes a plurality of sealed vanes 116 (see FIG. 2) that rotate around a drum and transport the insulation to an area where the air flow from blower 108 carries the insulation along path 120. The air lock 114 directs the air flow out through an outlet conduit 106 rather than back into the hopper 104.

In certain embodiments of the loose fill insulation delivery system, the hopper includes a shredder box configured to break apart the loose fill insulation. For example, loose fill insulation blowing machine 102 includes a shredder box 110 in the hopper 104 to begin breaking up the packaged loose fill insulation 190. The shredder box may include blades or other members that rotate through the hopper to break up the insulation.

In certain embodiments of the loose fill insulation delivery system, the loose fill insulation blowing machine includes a stator bar between the hopper and the air lock. For example, loose fill insulation blowing machine 102 includes a stator bar 112 positioned between the hopper 104 and the air lock 114. The stator bar 112 includes tines that prevent large masses of the insulation from passing into the air lock 114 and that also assist in opening the loose fill insulation 190 as it passes into the air lock 114. In other embodiments the blowing machine includes another structure between the hopper and the air lock to assist in conditioning the loose fill insulation, such as a screen or baffles. Still, in other embodiments, the blowing machine does not include such a structure between the hopper and the air lock. For instance, in some embodiments, the shredder box is configured to condition the insulation without a stator bar.

In certain embodiments of the loose fill insulation delivery system, the inlet port is located in the loose fill insulation blowing machine. For example, in loose fill insulation delivery system 100, the blowing machine 102 includes a housing 118 and an outlet conduit 106 extending from housing 118, where inlet port 130 is located in outlet conduit 106. Outlet conduit 106 extends from air lock 114 and is configured to connect to a loose fill insulation hose 140, as described in more detail below.

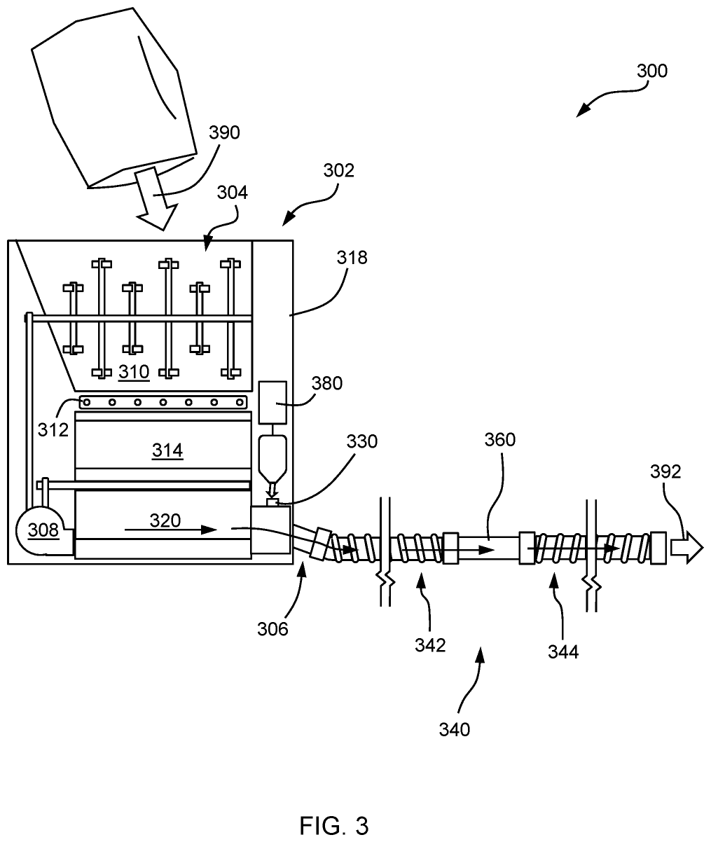

In other embodiments, the inlet port is located in another part of the blowing machine. For example, in some embodiments, the inlet port is located inside a housing of the blowing machine. Such an embodiment is shown in FIG. 3. Loose fill insulation system 300 includes a blowing machine 302 with a hopper 304 configured to receive loose fill insulation, an air lock 314 that receives the insulation from the hopper 304 and a blower 308 that conveys air along a path through outlet conduit 306 to convey the insulation from the blowing machine 302. Each of the hopper 304, air lock 314 and blower 308 are disposed within housing 318, and the outlet conduit 306 extends outward from housing 318. In contrast to the embodiment of loose fill insulation system 100, the inlet port 330 of system 300 is located inside housing 318 rather than in outlet conduit 306.

In certain embodiments of the loose fill insulation delivery system, the inlet port is downstream of the blower. Further, in some embodiments, the inlet port is downstream of the air lock. For example, in loose fill insulation system 100, inlet port 130 is located in the outlet conduit 106 at the exit from the blowing machine 102 and downstream of both the blower 102 and the air lock 114. Likewise, in loose fill insulation system 300, inlet port 330 is located inside housing 318 just downstream of air lock 314. In other embodiments, the inlet port is located upstream of the air lock. For example, in some embodiments, the inlet port is disposed between the blower and the air lock so that the air from the blower carries the first additive into the air lock where it interacts with the loose fill insulation. In other embodiments, the inlet port is disposed in the hopper or between the hopper and the air lock, so that the additive is mixed within the insulation within the blowing machine. Further still, in some embodiments, the inlet port is upstream of the blower. For example, in some embodiments, the additive is added to air that is entering the blower.

In other embodiments, the inlet port is located at another position along the path of the loose fill insulation. For example, in some embodiments, the loose fill insulation delivery system includes a hose and the inlet port is located in the loose fill insulation hose. In other embodiments, as in loose fill delivery systems 100 and 300, the loose fill insulation hose does not include any inlet ports.

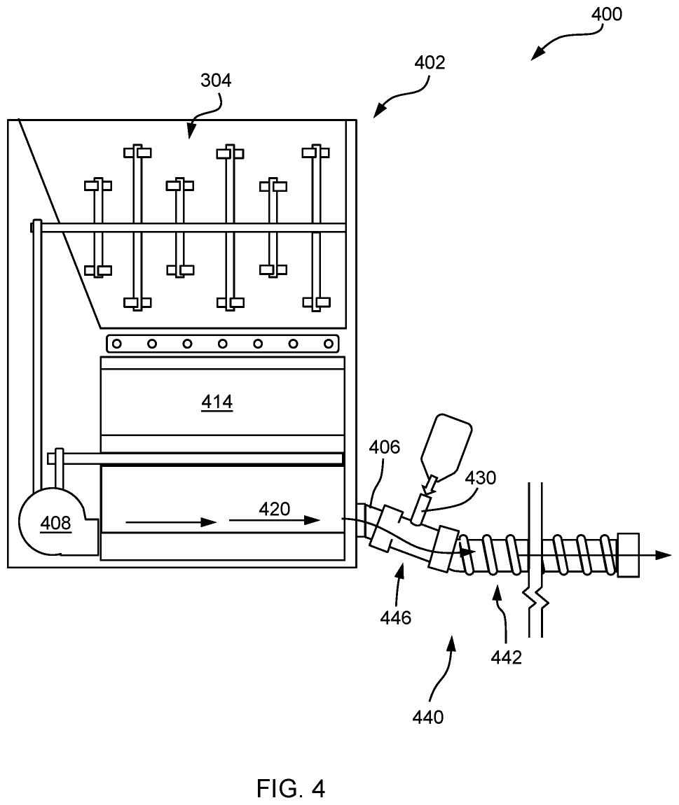

In certain embodiments of the loose fill insulation delivery system, the loose fill insulation hose includes a coupler attached to the loose fill insulation blowing machine. Such an embodiment is shown in FIG. 4. Loose fill insulation system 400 includes a blowing machine 402 with a hopper 404 configured to receive loose fill insulation, an air lock 414 that receives the insulation from the hopper 404 and a blower 408 that conveys air along a path 420 to outlet conduit 406. A hose 440 is coupled to the outlet conduit 406 for conveying the insulation along path 420 to an installation site. Specifically, the hose 440 includes a coupler 446 that attaches to a first hose section 442 and connects the hose section to outlet conduit 406. While coupler 446 includes a female end attached to outlet conduit 406 and a male end attached to first hose section 442, in other embodiments, the coupler may have another configuration. For example, in some embodiments, the male and female ends of the coupler are reversed. Further, in some embodiments both ends of the coupler are male, while in other embodiments both ends are female. Moreover, in some embodiments, the first hose section of the loose fill insulation hose is secured directly to the outlet conduit without a coupler.

In certain embodiments of the loose fill insulation delivery system, the inlet port is located in the coupler. For example, coupler 446 of loose fill insulation hose 440 includes inlet port 430 for supplying additive to loose fill insulation travelling along path 420. The location of inlet port 430 in coupler 446 provides additive at a location near the exit of blowing machine 402. Moreover, the inclusion of inlet port 430 within a portion of loose fill insulation hose 440 allows additive to be supplied to the loose fill insulation along path 420 without supplying the additive within the blowing machine 402. Accordingly, loose fill insulation hose 440 may offer the benefit of providing the additive to the loose fill insulation in system 400 without the need for blowing machine 402 to include an inlet port for the additive. On the other hand, in other embodiments, a loose fill insulation hose that includes an inlet port may be used with a blowing machine that also has an inlet port. Accordingly, the location for supplying additive may be selected by the user or the additive can be provided in more than one location.

In certain embodiments of the loose fill insulation delivery system, the loose fill insulation hose includes a first hose section, a second hose section, and a connection module coupling the first hose section and the second hose section. For example, loose fill insulation hose 340 of system 300 includes a first hose section 342 and a second hose section 344. A proximal end of first hose section 342 is coupled to outlet conduit 306 and the distal end of first hose section 342 is connected to second hose section 344 using connection module 360. Connection module 360 is hollow and forms a portion of the path 320 along which loose fill insulation travels to the installation site. Connection module 360 allows loose fill insulation hose 340 to reach locations far from blowing machine 302 without the need for a single long length of hose. While the embodiments in FIGS. 1 and 4 do not show a connection module within loose fill insulation hose 140 and loose fill insulation hose 440, similar embodiments may also include a connection module within the hose. Likewise, some embodiments may include a configuration similar to that of loose fill insulation delivery system 300, with a single hose section and without a connection module.

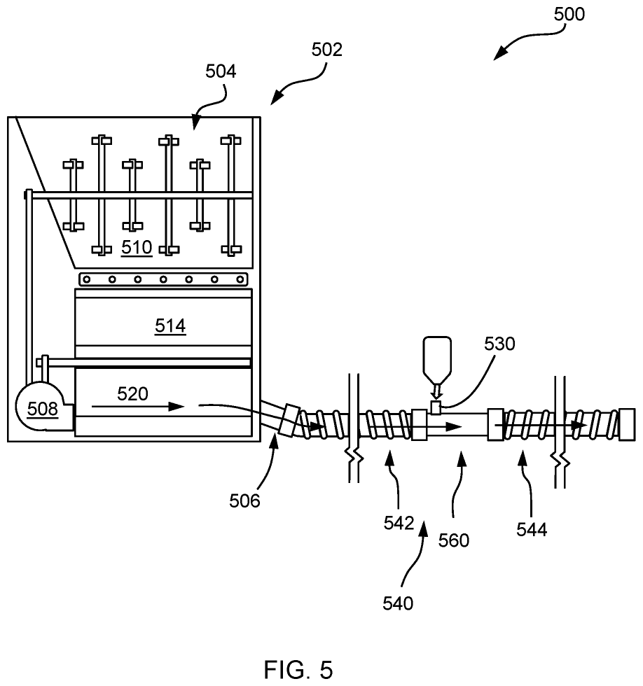

In certain embodiments of the loose fill insulation delivery system, the inlet port is located in the connection module. Such an embodiment is shown in FIG. 5. Loose fill insulation system 500 includes a blowing machine 502 with a hopper 504 configured to receive loose fill insulation, an air lock 514 that receives the insulation from the hopper 504 and a blower 508 that conveys air along a path 520 to outlet conduit 506. A hose 540 is coupled to outlet conduit 506 for conveying the insulation along path 520 to an installation site. Hose 540 includes a first hose section 542 and a second hose section 544 that are connected to each other by a connection module 560. The connection module 560 includes an inlet port 530 for introducing a first additive to loose fill insulation that is traveling along path 520 from loose fill insulation blowing machine 502 to the installation site.

In some embodiments, the hose of the loose fill insulation delivery system includes a plurality of connection modules. For example, in some embodiments, the loose fill insulation hose includes a group of hose sections and a respective connection module that couples each pair of adjacent hose sections along the length of the hose. Further, in some embodiments, the loose fill insulation hose includes a connection module at the proximal end of the hose. For example, in some embodiments, the loose fill insulation hose includes a connection module positioned between a coupler that is attached to the blowing machine and the first hose section. In other embodiments, the coupler has the same configuration as one of the connection modules. Further, in some embodiments, the first hose section is connected directly to the outlet conduit of the blowing machine.

Similarly, in some embodiments, the hose of the loose fill delivery system includes a connection module at a distal end thereof. For example, in some embodiments the loose fill insulation hose may include a connection module at a distal end of the hose. Further, in some embodiments, the loose fill connection hose may include an outlet nozzle attached to the connection module at the distal end of the hose. Still, in other embodiments, the loose fill insulation module may exclude a connection module at the distal end. For example, in some embodiments, an outlet nozzle is connected directly to a hose section at the distal end. Further, in other embodiments, the end of the hose is formed by a hose section, and neither a connection module nor an outlet nozzle is included at the end.

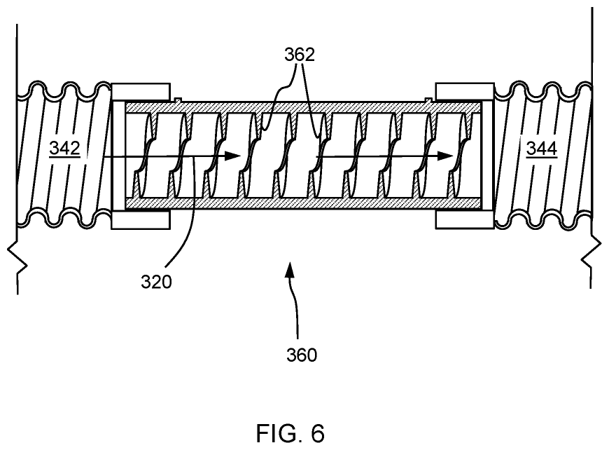

In certain embodiments of the loose fill insulation delivery system, the connection module includes projections extending inward into the path of the loose fill insulation, the projections being configured to open the loose fill insulation. The projections are configured to open the loose fill insulation. As air flowing through the hose carries the loose fill insulation through the connection module, fibers or particles of the loose fill insulation may catch on the projections of the connection module and be pulled open or apart. Further, the projections can create turbulence in the airflow passing through the connection module, which may lead to tumbling or other motion that can help open the loose fill insulation as it passes through the connection module. For example, FIG. 6 shows a cross-sectional view of connection module 360 of hose 340 of loose fill insulation delivery system 300, shown in FIG. 3. As illustrated, loose fill insulation hose 340 includes a first hose section 342 that is connected to a second hose section 344 by connection module 360. The connection module 360 includes projections 362 along the length of connection module 360. The projections 362 form part of an interior surface of the connection module 360 and extend into the path 320 along which the loose fill insulation travels. Accordingly, the projections 362 interact with loose fill insulation passing through the connection module 360.

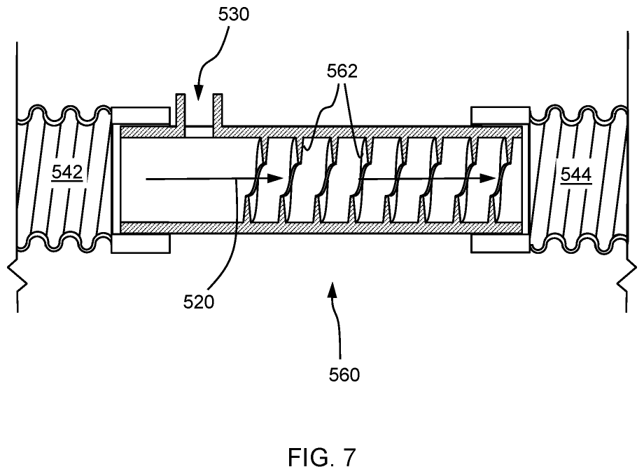

Connection module 560 of loose fill insulation delivery system 500, as shown in FIG. 5, also includes such projections. For example, FIG. 7 shows a cross-sectional view of connection module 560 that connects first hose section 542 and second hose section 544. The interior surface of connection module 560 includes a plurality of projections 562 along a portion of the length of connection module 560. Again, the projections are configured to help open the loose fill insulation as it travels along path 520.

In certain embodiments of the loose fill insulation delivery system, the projections are connected on a helical path. For example, the projections 362 of connection module 360, as shown in FIG. 6, are formed by a continuous projecting structure that extends around the circumference of the interior surface in a helix along the length of first connection module 360. Accordingly, this single continuous structure forms a plurality of projections into the path 320 of the loose fill insulation. Projections 562 of connection module 560, as shown in FIG. 7, have a similar configuration. In other embodiments, the projections may be formed by continuous structures having other shapes. Further, in some embodiments, the projections are formed by discrete structures that individually extend inward toward the middle of the connection module.

In some embodiments, the connection module includes an inlet port that is upstream of the projections. For example, as shown in FIG. 7, connection module 560 of loose fill insulation delivery system 500 includes inlet port 530 upstream of projections 562. In other embodiments, the connection module includes an inlet port downstream of the projections. Alternatively, in some embodiments, the connection module is reversible so that the inlet port can be positioned at the upstream end or at the downstream end. Further still, in some embodiments, the inlet port is positioned in the middle of the connection module. In such embodiments, projections may be positioned both upstream and downstream of the inlet port.

In certain embodiments of the loose fill insulation delivery system, internal diameter of connection module is at least 1.5 inches, e.g., at least 2 inches, e.g., at least 2.5 inches. In some embodiments, the internal diameter of the connection module is no more than 12 inches, e.g., no more than 10 inches, e.g., no more than 8 inches. For example, in some embodiments, the internal diameter of the connection module is in a range from 2 inches to 12 inches, e.g., from 2.5 inches to 8 inches.

In certain embodiments of the loose fill insulation delivery system as otherwise described herein, at least a portion of loose fill insulation hose is corrugated. For example, as shown in FIG. 3, first hose section 342 of loose fill insulation hose 340, has a corrugated tubular body 346. Corrugated hose can have increased flexibility and strength compared to similar hose with a smooth outer surface. The second hose section 344 of loose fill insulation hose 340 is similarly corrugated.

In certain embodiments of the loose fill insulation delivery system as otherwise described herein, the first hose section has a length of at least 10 feet, e.g., at least 15 feet, e.g., at least 20 feet. In some embodiments, the first hose section has a length of no more than 100 feet, e.g., no more than 80 feet, e.g., no more than 60 feet, e.g., about 50 feet. For example, in some embodiments, the first hose section has a length in a range from 10 feet to 100 feet, e.g., from 12 feet to 80 feet, e.g., from 15 feet to 60 feet, e.g., from 20 feet to 50 feet. In some embodiments each of the hose sections has the same length. In other embodiments the hose sections of the loose fill insulation hose have different lengths.

In certain embodiments of the loose fill insulation delivery system as otherwise described herein, an inner diameter of the first hose section is at least 1.5 inches, e.g., at least 2 inches, e.g., at least 2.5 inches. In some embodiments, an inner diameter of the first hose section is no more than 12 inches, no more than 10 inches, no more than 8 inches. For example, in some embodiments, the inner diameter of the first hose section is in a range from 1.5 inches to 12 inches, e.g. from 2 inches to 10 inches, e.g., from 2.5 inches to 8 inches. Further, in some embodiments each of the hose sections has the same inner diameter. In other embodiments, some of the hose sections within the hose have different inner diameters. For example, in some embodiments, the hose sections reduce in diameter along the length of the hose. In other embodiments, the hose sections increase in diameter along the length of the hose. Still, in other embodiments, the hose sections may both increase and decrease in diameter along the length of the hose. Such changes in diameter along the length of the hose may change the pressure within the hose, thereby allowing for more mixing of the first additive and the loose fill insulation, may increase or decrease the exit pressure from the hose, or provide other beneficial fiber handling results.

In certain embodiments of the loose fill insulation delivery system, the inlet port is positioned at least 25 feet from a distal end of the loose fill insulation hose. For example, in each of the embodiments shown in FIGS. 1, 3, and 4, the respective loose fill insulation hose is longer than 25 feet. Accordingly, in each of these embodiments the inlet hose, which is positioned either in the blowing machine or at the proximal end of the hose, is more than 25 from the distal end of the loose fill insulation hose. Likewise, in loose fill insulation delivery system 500, shown in FIG. 5, the second hose section 544 of loose fill insulation hose 540 is longer than 25 feet, such that inlet port 530 located in connection module 560 is more than 25 from the distal end of loose fill insulation hose 540. In other embodiments, the inlet port is closer to the distal end of the hose. Moreover, in some embodiments the system is provided without a hose, and a separate hose can be attached to the system.

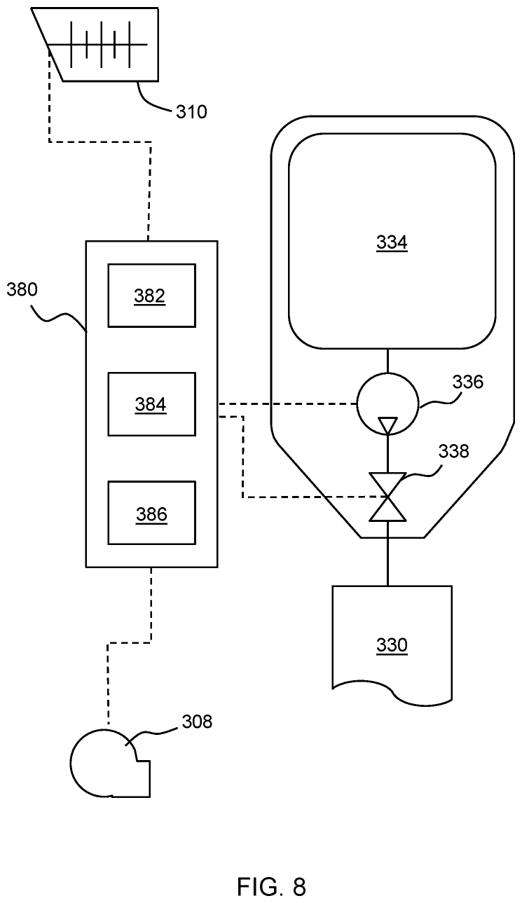

In certain embodiments of the loose fill insulation delivery system, the inlet port is connected to a pump configured to meter the first additive into the path of the loose fill insulation. Further, in some embodiments, the inlet port is connected to a valve configured to meter the first additive into the path of the loose fill insulation. For example, FIG. 8 shows a detailed schematic view of the fluid connection between a container 334 that stores the first additive and the inlet port 330 of loose fill insulation delivery system 300. As illustrated, the container 334 is coupled to inlet port 330 via a valve 338. Valve 338 is configured to meter the first additive into inlet port 330. Further, the container 334 and valve 338 are also coupled to a pump 336 that propels the first additive through inlet port 330.

While the embodiment shown in FIG. 8 includes both a pump and a valve, in some embodiments the loose fill insulation delivery system includes a valve without a pump. For example, in some embodiments a pressure differential between the container and the path of the loose fill insulation causes the first additive to be metered into the inlet port by the valve alone. For example, the valve may be configured to slowly meter the first additive into the inlet port based on the pressure differential, or the valve may be actively controlled to meter the first additive. In other embodiments, the pump may be able to control the delivery of the first additive from the container without the use of a separate valve. Further still, in some embodiments, the system may be configured to receive a container that meters the first additive in one of the aforementioned or another manner.

FIG. 8 also shows a computing device 380 that includes a non-transitory computer-readable medium with program instructions stored thereon for performing a method of the disclosure, as described in more detail below. For example, computing device 380 is coupled to pump 336 and valve 338 in order to control the metering of first additive into inlet port 330. For example, in some embodiments, the computing device 380 sends control signals to the pump 336 to operate the pump. Likewise, in some embodiments, the valve 338 is an electromechanical valve and the computing device sends control signals to the valve 338 to control operation of the valve 338 for metering out the first additive.

Computing device 380 is also coupled to blower 308 and shredder box 310 and is configured to provide control signals or control electrical power to these components to condition loose fill insulation and drive it along path 320. In other embodiments, the computing device is coupled to a separate motor that operates the blower and/or shredder box. Computing device 380, as illustrated, includes a processor 382, a memory 384, and a network interface 386. In other embodiments, the computing device may have other configurations.

Processor 382 of computing device 380 includes a computer processing element, e.g., a central processing unit (CPU), an integrated circuit that performs processor operations, a digital signal processor (DSP), or a network processor. In some embodiments, the processor includes register memory that temporarily stores instructions being executed and corresponding data, as well as cache memory that temporarily stores performed instructions. Memory 384 is a computer-usable memory, e.g., random access memory (RAM), read-only memory (ROM), or non-volatile memory such as flash memory, solid state drives, or hard-disk drives. In certain embodiments, memory 384 stores program instructions that are executable by processor 382 for carrying out the methods and operations of the disclosure. Network interface 386 provides digital communication between computing device 380 and other computing systems or devices. In some embodiments, the network interface operates via a physical wired connection, such as an ethernet connection. In other embodiments, the network interface communicates via a wireless connection, e.g., IEEE 802.11 (Wifi) or BLUETOOTH. Other communication conventions are also possible.

While the container, pump, valve and computing device are described above with respect to loose fill insulation delivery system 300, other embodiments may also include these components, such as the embodiments of FIGS. 1, 4, and 5, as well as other embodiments.

While the embodiments of a loose fill insulation delivery system described above include a single inlet port for additives, in other embodiments, the inlet port is one of several inlet ports configured to provide additive along the path of the loose fill insulation. For example, in some embodiments, the loose fill insulation delivery system includes an inlet port located in the blowing machine and a second inlet port located in the loose fill insulation hose. Further still, in some embodiments, the system includes a plurality of inlet ports for delivering additives along the path of the loose fill insulation. In some embodiments the same additive or mixture of additives is delivered through each inlet port, while in other embodiments, a different additive or a different mixture of additives is delivered through different inlet ports.

In another aspect, the disclosure provides a method of delivering loose fill insulation to an installation site using the system of the disclosure. The method includes loading loose fill insulation into the hopper and operating the blower to convey the loose fill insulation along a path to the installation site. The method also includes introducing a first additive into the loose fill insulation that is travelling along the path through an inlet port.

Such a method is depicted in FIG. 3. Packed insulation 390 is initially introduced into blowing machine 302 via the hopper 304. The packed insulation 390 is broken up and opened by the shredder box 310 and stator bar 312 as it moves into air lock 314. The air lock 314 then moves the insulation to a position where air from blower 308 can carry the insulation through outlet conduit 306 and into loose fill insulation hose 340. The loose fill insulation is then conveyed to an installation site at the distal end of hose 340, where the loose fill insulation 392 is delivered to the installation site. As the insulation passes through outlet conduit 306, a first additive is provided to the loose fill insulation through inlet port 330, as described above. Methods using each of the embodiments of systems 300, 400, and 500, as shown in FIGS. 1, 4, and 5, are similar, with additive being introduced to the loose fill insulation using inlet ports located at other positions along the path to the installation site, as described above.

In certain embodiments, the method of the disclosure may be carried out by the controller 380. For example, in some embodiments, the controller 380 sends control signals to the shredder box 310 and blower 308 in order to condition the loose fill insulation and then convey the loose fill insulation through hose 340. In other embodiments, the controller 380 sends control signals to a motor that operates both the shredder box 310 and blower 308. Likewise, in some embodiments, the controller 380 sends control signals to one of or both the pump 336 and valve 338 to meter the first additive 332 through the inlet port 330 where it is introduced to the insulation.

In certain embodiments of the method as otherwise described herein, the first additive includes an antistatic agent. In other embodiments, the first additive includes a dust suppressant, mold suppression agent, moisture control agent, fire retardant, IR blocking agent, opacifier, coloring agent, or pest control agent.

In certain embodiments of the method as otherwise described herein, the first additive is mixed with additional additives. For example, in some embodiments, the first additive is included in a solution that includes one or more additional additives. The additional additives may have compositions that complement the function of the first additive or that perform other functions. For example, in some embodiments, a solution may be introduced through the inlet port that includes an antistatic agent as the first additive and also a dust suppressant. Further, in some embodiments, the first additive may have more than one function. For example, in some embodiments, the first suppressant may be a dust suppressant that also functions as a fire retardant.

In some embodiments, the first additive is contained in a solution that includes water. For example, in some embodiments the first additive is contained in a solution that is up to 50% water. In other embodiments the first additive is contained in a solution that is more than 50% water, e.g., more than 60% water, e.g., more than 70% water, e.g., more than 80% water, e.g., more than 90% water, e.g., more than 95% water. Further, in some embodiments, the first additive is contained in a solution comprising a liquid other than water. Further still, in some embodiments the first additive is a dry additive. For example, in some embodiments, the first additive is a powder or other solid.

In certain embodiments of the method as otherwise described herein, the loose fill insulation loaded into the hopper is free of the first additive. For example, in some embodiments the packed loose fill insulation does not include the first additive. Instead, the first additive is only added to the loose fill insulation through the inlet port. Accordingly, none of the first additive will be lost in the system upstream of the first inlet port. Moreover, this allows the amount of first additive in the installed insulation to be controlled at the location of the installation based on the environment and need for this location. For example, the installer may determine that the location is damp and increase the quantity of additive used where the first additive is a moisture control agent.

In certain embodiments of the method as otherwise described herein, the method also includes opening the loose fill insulation passing through the connection module using projections extending inward into the path along which the loose fill insulation is traveling. For example, as the loose fill insulation in system 300 passes through first connection module 360, the projections 362 interact with the insulation and further open the insulation, as explained in more detail above.

In certain embodiments of the method as otherwise described herein, the loose fill insulation includes a fibrous material. For example, in some embodiments, the loose fill insulation is a fiberglass insulation, a cellulose insulation, a stonewool insulation, a plastic fiber insulation, a natural wool insulation, a natural cotton insulation, or another insulation including fibers. In other embodiments, the loose fill insulation includes small insulating components, such as a foam bead insulation or a plastic particle insulation. Still, in other embodiments, the loose fill insulation may be formed of another type of insulation that can build electric static potential as it passes through the loose fill insulation hose.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

### Embodiments

Embodiment 1. A loose fill insulation delivery system comprising:
   a hopper configured to receive loose fill insulation;
   a blower operable to convey loose fill insulation along a path toward an installation site; and
   an inlet port located along the path and configured to introduce a first additive into loose fill insulation travelling along the path toward the installation site.
Embodiment 2. The loose fill insulation delivery system according to embodiment 1, wherein the hopper and blower are part of a loose fill insulation blowing machine.
Embodiment 3. The loose fill insulation delivery system according to embodiment 2, wherein the loose fill insulation blowing machine includes an air lock configured to transfer the loose fill insulation to the outlet.
Embodiment 4. The loose fill insulation delivery system according to embodiment 2 or embodiment 3, wherein the loose fill insulation blowing machine includes a stator bar between the hopper and the air lock.
Embodiment 5. The loose fill insulation delivery system according to any of embodiments 2 to 4, wherein the hopper includes a shredder box configured to break apart the loose fill insulation.
Embodiment 6. The loose fill insulation delivery system according to any of embodiments 2 to 5, wherein the inlet port is located in the loose fill insulation blowing machine.
Embodiment 7. The loose fill insulation delivery system according to any of embodiments 2 to 6, wherein the loose fill insulation blowing machine includes a housing.
Embodiment 8. The loose fill insulation delivery system according to embodiment 7, wherein the inlet port is inside the housing.
Embodiment 9. The loose fill insulation delivery system according to any of embodiments 1 to 8, wherein the inlet port is downstream of the blower.
Embodiment 10. The loose fill insulation delivery system according to any of embodiments 1 to 9, wherein the inlet port is downstream of the air lock.
Embodiment 11. The loose fill insulation delivery system according to any of embodiments 1 to 7, wherein the loose fill insulation blowing machine includes an outlet conduit extending from the housing.
Embodiment 12. The loose fill insulation delivery system according to embodiment 11, wherein the inlet port is located in the outlet conduit.
Embodiment 13. The loose fill insulation delivery system according to any of embodiments 1 to 7, further comprising a loose fill insulation hose coupled to the loose fill insulation blowing machine.
Embodiment 14. The loose fill insulation delivery system according to embodiment 13, wherein the loose fill insulation hose includes a coupler attached to the loose fill insulation blowing machine.
Embodiment 15. The loose fill insulation delivery system according embodiment 14, wherein the inlet port is located in the coupler.
Embodiment 16. The loose fill insulation delivery system according to any of embodiments 13 to 15, wherein the loose fill insulation hose includes a first hose section, a second hose section, and a connection module coupling the first hose section and the second hose section.
Embodiment 17. The loose fill insulation delivery system according to embodiment 16, wherein the inlet port is located in the connection module.
Embodiment 18. The loose fill insulation delivery system according to embodiment 16 or embodiment 17, wherein the connection module includes projections extending inward into the path of the loose fill insulation, the projections being configured to open the loose fill insulation.
Embodiment 19. The loose fill insulation delivery system according to embodiment 18, wherein the projections are connected on a helical path.
Embodiment 20. The loose fill insulation delivery system according to any of embodiments 1 to 19, wherein the inlet port is connected to a pump configured to meter the additive into the path of the loose fill insulation.
Embodiment 21. The loose fill insulation delivery system according to any of embodiments 1 to 19, wherein the inlet port is connected to a valve configured to meter the additive into the path of the loose fill insulation.
Embodiment 22. The loose fill insulation delivery system according to any of embodiments 1 to 21, further comprising a container configured to store the first additive, wherein the container is coupled to the inlet port.
Embodiment 23. A method of delivering loose fill insulation to an installation site using the system according to any of embodiments 1 to 22, the method comprising:
   loading loose fill insulation into the hopper;
   operating the blower to convey the loose fill insulation along a path to the installation site; and
   introducing a first additive to the loose fill insulation travelling along the path through an inlet port.
Embodiment 24. The method according to embodiment 23, wherein the first additive includes an antistatic agent.
Embodiment 25. The method according to embodiment 23, wherein the first additive includes a dust suppressant, mold suppression agent, moisture control agent, fire retardant, IR blocking agent, opacifier, coloring agent or pest control agent.
Embodiment 26. The method according to any of embodiments 23 to 25, wherein the first additive is mixed with additional additives.
Embodiment 27. The method according to any of embodiments 23 to 26, wherein the loose fill insulation loaded into the hopper is free of the first additive.
Embodiment 28. The method according to any of embodiments 23 to 27, further comprising opening the loose fill insulation passing through the connection module using projections extending inward into the path along which the loose fill insulation is traveling.
Embodiment 29. The method according to any of claims 23 to 28, wherein the loose fill insulation includes a fibrous material.

What is claimed is:

1. A loose fill insulation delivery system comprising:
a loose fill insulation blowing machine comprising:
a hopper configured to receive loose fill insulation, and
a blower operable to convey loose fill insulation along a path toward an installation site; and
an inlet port located along the path and configured to introduce a first additive into loose fill insulation travelling along the path toward the installation site.

2. The loose fill insulation delivery system according to claim 1, wherein the inlet port is located in the loose fill insulation blowing machine.

3. The loose fill insulation delivery system according claim 1, further comprising a loose fill insulation hose coupled to the loose fill insulation blowing machine, and wherein the inlet port is located in the loose fill insulation hose at least 25 feet from a distal end of the loose fill insulation hose.

4. The loose fill insulation delivery system according to claim 2, wherein the loose fill insulation blowing machine includes an outlet conduit extending from the housing, and wherein the inlet port is located in the outlet conduit.

5. The loose fill insulation delivery system according to claim 2, wherein the loose fill insulation blowing machine includes a housing.

6. The loose fill insulation delivery system according to claim 5, wherein the inlet port is inside the housing.

7. The loose fill insulation delivery system according to claim 2, wherein the loose fill insulation blowing machine includes an air lock, and wherein the inlet port is downstream of the air lock.

8. The loose fill insulation delivery system according to claim 3, wherein the loose fill insulation hose includes a first hose section, a second hose section, and a connection module coupling the first hose section and the second hose section.

9. The loose fill insulation delivery system according to claim 8, wherein the connection module includes projections extending inward into the path of the loose fill insulation, the projections being configured to open the loose fill insulation.

10. The loose fill insulation delivery system according to claim 8, wherein the inlet port is located in the connection module.

11. The loose fill insulation delivery system according to claim 1, wherein the inlet port is connected to at least one of a pump and a valve configured to meter the additive into the path of the loose fill insulation.

12. A method of delivering loose fill insulation to an installation site using the system according to claim 1, the method comprising:
loading loose fill insulation into the hopper;
operating the blower to convey the loose fill insulation along a path to the installation site; and
introducing a first additive to the loose fill insulation travelling along the path through the inlet port.

13. The method according to claim 12, wherein the first additive includes an antistatic agent.

14. The method according to claim 12, wherein the first additive includes a dust suppressant, mold suppression agent, moisture control agent, fire retardant, IR blocking agent, opacifier, coloring agent or pest control agent.

15. The method according to claim 12, wherein the first additive is mixed with additional additives.
